(19) United States
(12) Patent Application Publication
(10) Pub. No.: US 2016/0150056 A1
(43) Pub. Date: May 26, 2016

(54) MULTI-PROTOCOL FRAME FILTER

(71) Applicant: Atmel Corporation, San Jose, CA (US)

(72) Inventors: Thomas Hanusch, Coswig (DE); Udo Walter, Dresden (DE); Falk Hofmann, Dresden (DE)

(21) Appl. No.: 14/550,491

(22) Filed: Nov. 21, 2014

(51) Int. Cl. H04L 29/06; H04W 52/02; H04W 28/02

(52) U.S. Cl. CPC H04L 69/18; H04W 28/0221; H04W 52/0229

(57) ABSTRACT

Systems, methods and circuits implementing a multi-protocol frame filter are disclosed. In some implementations, one or more programmable registers are configured to store frame filter data. A receiver is configured to receive an incoming frame. A multi-protocol frame filter is coupled to the one or more programmable registers and the receiver. The multi-protocol frame filter is configured for: comparing one or more fields of the incoming frame to the frame filter data, where the one or more fields are indicative of a wireless communications protocol; and determining, based on the comparing, to accept or discard the frame.

### TECHNICAL FIELD

This disclosure relates generally to wireless protocol frame filtering.

### BACKGROUND

Wireless standards define frame formats for data exchange. Within a given standard or standard version, the contents of frame fields can be used to specify a semantic for other frame fields. Because each standard and standard version may use frames differently, if a standard is changed or updated a new wireless transceiver may be required.

### SUMMARY

Systems, methods and circuits implementing a multi-protocol frame filter are disclosed.

In some implementations, a multi-protocol frame filter system includes one or more programmable registers configured to store frame filter data. A receiver is configured to receive an incoming frame. A multi-protocol frame filter is coupled to the one or more programmable registers and the receiver. The multi-protocol frame filter is configured for: comparing one or more fields of the incoming frame to the frame filter data, where the one or more fields are indicative of a wireless communications protocol; and determining, based on the comparing, to accept or discard the frame.

In some implementations, a multi-protocol frame filter system includes one or more programmable registers configured to store frame filter data. A receiver is configured to receive an incoming frame having one or more fields, the one or more fields being indicative of a wireless communications protocol and include frame type and frame version. A multi-protocol frame filter is configured to: conduct a first comparison of the one or more fields to the frame filter data; make a determination, based on the first comparison, to accept the frame type or frame version fields; conduct a second comparison, based on the determination, of one or more other fields to one or more filter rules; and enable a subsequent processing of the frame based on the second comparison indicating that the one or more other fields of the frame comply with the one or more filter rules.

In some implementations, a method comprises: programming one or more registers in a wireless transceiver circuit with frame filter data; receiving, by a receiver of the wireless transceiver circuit, an incoming frame; comparing, by a multi-protocol frame filter of the wireless transceiver circuit that is coupled to the one or more registers and the receiver, one or more fields of the incoming frame to the frame filter data, where the one or more fields are indicative of a wireless communications protocol; and determining, based on the comparing, to accept or discard the frame.

### BRIEF DESCRIPTION OF THE DRAWINGS

FIG. 1 is a block diagram of a multi-protocol frame filter system according to some implementations.

FIGS. 2A and 2B illustrate a general MAC frame format and frame control field for a wireless communications protocol, respectively.

FIG. 3 is flow diagram of multi-protocol frame filter process according to some implementations.

### DETAILED DESCRIPTION

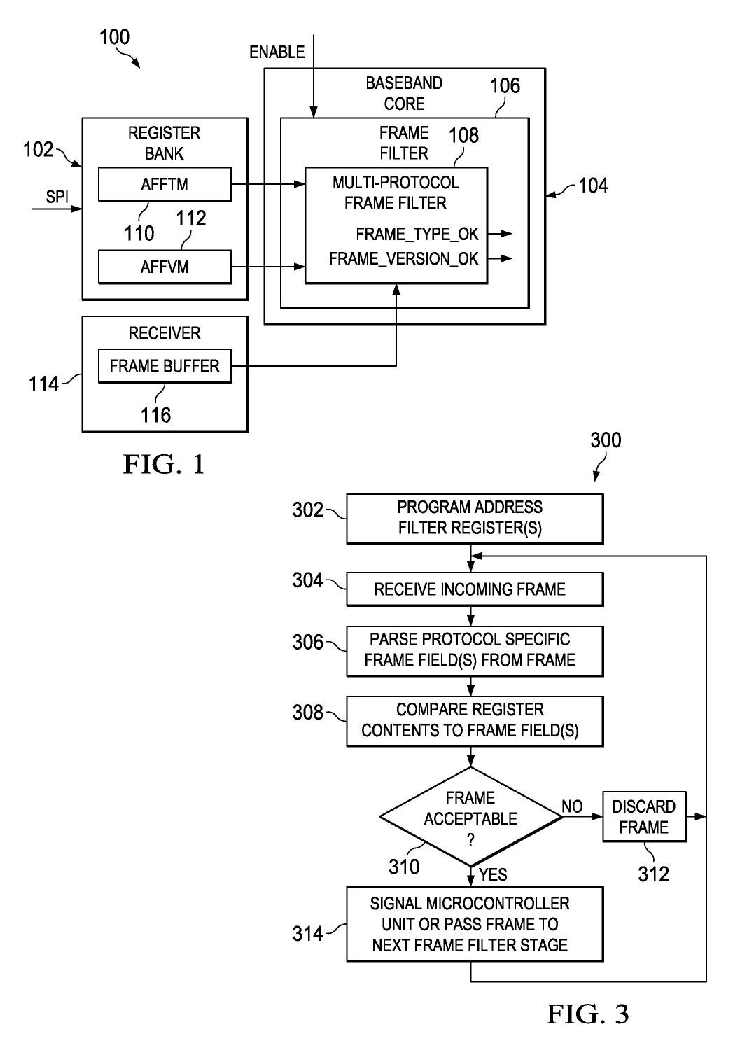

FIG. 1 is a block diagram of a multi-protocol frame filter system 100 according to some implementations. System 100 can include register bank 102, baseband core 104, multi-stage address filter 106 and multi-protocol frame filter 108. Register bank 102 further comprises programmable frame filter configuration registers 110 (A), 112 (B). Receiver 114 further includes frame buffer 116 for storing frames received over-the-air (OTA). In some implementations, system 100 is included in a wireless transceiver integrated circuit (IC) chip.

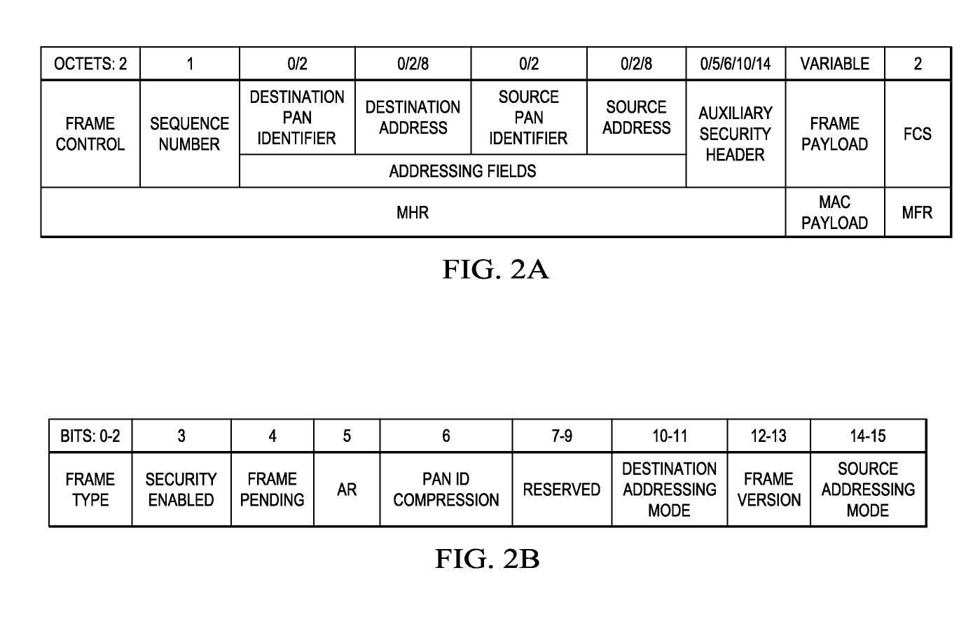

Registers 110, 112 can be programmed over an interface, such as, for example, by an external microcontroller unit (MCU) over a Serial Peripheral Interface (SPI). In some implementations, register 110 stores frame filter data. Frame filter data can include any data that can be compared to one or more frame fields to determine a match. In the example described herein, register 110 stores an address filter frame type mask (AFFTM) and register 112 stores an address filter frame version mask (AFFVM). Incoming frames that are received OTA are stored in frame buffer 116. The frame can be formatted according to a wireless communications protocol. An example wireless communications protocol is IEEE amendment “IEEE Std. 802.15.4g™-2012”, as described in reference to FIGS. 2A and 2B.

Referring to FIGS. 2A and 2B, a general Media Access Control (MAC) frame and frame control field for IEEE802.15.4g are shown. The MAC command frame structure includes three sections: MAC header (MHR), MAC payload and MAC footer (MFR). The MHR comprises several fields including frame control, sequence number frame, addressing field and optional auxiliary security field.

The frame control field is shown in FIG. 2B and corresponds to the frame control field shown in FIG. 2A. The frame control field includes frame type and frame version portions. Content in the frame type portion specifies a frame type for the frame, such as a data frame. Content in the frame version portion specifies a frame version. Together the frame type and the frame version provide a semantic for reading other fields in the frame. For example, if frame type specifies a data frame, then the receiver can use this information to read data from the MAC payload. Frame version indicates which version of IEEE802.15.4 is to be used to process the MAC command frame.

Referring again to FIG. 1, multi-protocol frame filter 108 takes as inputs an incoming frame stored in frame buffer 116 and the frame filter data (e.g., bit masks) stored in registers 110, 112. In some implementations, multi-protocol frame filter 108 can be a first stage of multi-stage address filter 106. In the example shown, multi-stage address filter 106 is part of baseband core 104 and operates in the physical (PHY) layer. In some implementations, multi-stage address filter 106, including multi-protocol frame filter 108, can be implemented at least partially in software.

In some implementations, the incoming frame is parsed to recover the frame control field and other fields. Multi-protocol frame filter 108 compares the bit masks stored in registers 110, 112 to the frame type and frame version bit settings in the frame control field, respectively, to determine if the bit masks match the bit settings. Each bit in register 110 represents a frame type number. Each bit in register 112 represents a frame version number. The incoming frame contains a frame type number and a frame version number that are mapped to a corresponding bit in registers 110, 112, respectively. With this approach, several frame type and frame version numbers can be configured by registers 110, 112, respectively, to pass multi-protocol frame filter 108. If one or more bits in the frame type mask are set (e.g., set to “1”) and the corresponding number of the incoming frame type matches its corresponding set mask bit, the incoming frame is passed by multi-protocol frame filter 108. Otherwise, the frame is discarded. For example, an 8-bit mask stored in register 110 can be set with hexadecimal number 0x0B resulting in the bit settings “00001011” where the least significant bit (LSB) position in register 110 corresponds to a frame type number 0 and increases to a maximum of 8 frame types with the most significant bit (MSB) corresponding to frame type number 7. With this example bit mask stored in register 110, incoming frames having a frame type number of 0, 1 or 3 would be passed by multi-protocol frame filter 108 and incoming frames having a frame type number of 2, 4, 5, 6, or 7 would be discarded by multi-protocol frame filter 108.

Register 112 storing a bit mask for frame version operates in a similar manner. For example, a 4-bit mask stored in register 112 can be set with hexadecimal number 0xC resulting in bit settings “1100.” With this example bit mask stored in register 112, incoming frames having a frame version number of 2 or 3 would be passed by multi-protocol framer filter 108 and incoming frames having a frame version number of 0 or 1 would be discarded by multi-protocol frame filter 108.

Based on results of the comparing, the frame type and frame version are either accepted or discarded by multi-protocol frame filter 108. In some implementations, multi-protocol frame filter 108 is configured to generate binary signals (logic “1” or “0”) indicating acceptance or discarding of frame type and frame version, respectively. Example frame type and frame version register configurations are shown in Table I below.

TABLE I
Example Address Filter Registers

| Register | | Size | Reset | |
|---|---|---|---|---|
| Name | Attribute or Name | [bits] | Value | Comment |
| AFFTM | frame type bitmask | 8 | 0x0B | Address filter frame |
| | | | | type bit mask |
| AFFVM | frame version bitmask | 4 | 3 | Address filter frame |
| | | | | version mask |

As shown in Table I, the frame type bit mask (AFFTM) can be 8 bits and reset with hexadecimal value Ox0B (Ser. No. 00/001,011′b), which by default allows frame type numbers 0, 1 and 3 to pass and discards all other frame type numbers. The frame version bit mask (AFFVM) can be 4 bits and reset with Ox3 or (0011′b), which by default allows wireless protocol versions 0 and 1 to pass and discards all other versions. The register sizes can be any size and not limited the sizes shown in Table I. Any of the bits in these registers can be set individually or together by, for example, an external MCU over an interface (e.g., SPI interface). This allows the device (e.g., a wireless transceiver IC chip) to be configured “on-the-fly” as desired for an application, avoiding the need to develop new hardware when wireless communication protocols or protocol versions change or are otherwise updated.

In some implementations, the binary signals can be inputs to an AND gate (not shown). The output of the AND gate produces a logic “1” to indicate acceptance of both the frame type and frame version when both inputs are logic “1”. The output of the AND gate is provided to multi-stage address filter 106. If the frame is accepted (based on the frame type and frame version matching the contents of registers 110, 112), multi-stage address filter 106 applies additional filtering to the frame. Accordingly, multi-protocol frame filter 108 discards frames that are not addressed to the wireless transceiver IC chip and thus avoids the need to analyze the complete OTA traffic.

In some implementations, if the frame is accepted by multi-protocol frame filter 108, multi-stage address filter 106 applies additional filter stages, each having a different set of filter rules. For example, additional filter stages can test for matches of personal area network (PAN) identifiers, short addresses and extended addresses with settings in configuration registers of the wireless transceiver IC chip. If an incoming frame passes all of the filter stages of multi-stage address filter 106, the frame can be stored in a receiver (RX) frame buffer and an interrupt signal generated for an external microcontroller unit (MCU) to read the frame from the RX buffer and perform subsequent processing of the frame.

By discarding frames based on the output of a first stage of address filter 106, the multi-protocol frame filter 108 reduces MCU to wireless transceiver interactions, resulting in, for example, a reduction in power consumption by the MCU. Multi-protocol frame filter 108 allows continuing use of embedded hardware blocks even if the wireless communications protocol or its version is changed. Thus, the performance and power consumption advantages of frame filter 106 are preserved if the wireless communications protocol or its version is changed.

The multi-protocol frame filter described above is applicable to a radio transceiver that follows the IEEE802.15.4 protocol but it is not limited to this protocol. Rather, the multi-protocol frame filter can be used to support other wireless communications protocols and protocol versions such as ETSI TS 102 887-2, ANSI/TIA-4957.200 or proprietary protocols. The frame type bit mask and the frame version bit mask can be configured independently. The frame type bit mask can be configured to pass a certain single frame type, a group of frame types or all frame types or no frames. The frame version bit mask can be configured to pass a certain single version number, up to a certain number or all version numbers. Multiple dedicated registers or a single register (a single register divided into sub registers) can be used to store frame type and frame version bit masks.

FIG. 3 is flow diagram of frame filter process 300 according to some implementations. Process 300 can be implemented by, for example, system 100, described in reference to FIG. 1.

In some implementations, process 300 can begin by programming address filter register(s) with frame filter data (302). In some implementations, the frame filter data are bit mask(s). The register(s) can be programmed, for example, by an external MCU using an interface (e.g., SPI).

Process 300 can continue by receiving an incoming frame OTA (304), parsing protocol specific frame field(s) from the incoming frame (306). In some implementations, the frame fields are indicative of a wireless communications protocol, such as IEEE802.15.4g or ETSI TS 102 887. Some examples of protocol specific frame fields are frame type and frame version. The frame type number indicates a type for the incoming frame (e.g., a data frame) and the frame version number indicates the version of the wireless communications protocol. The frame type and frame version numbers, individually or together provide a semantic for reading other frame fields. The frame type and frame version can be different for different wireless communications protocols and/or protocol versions.

Process 300 can continue by comparing register (s) contents to the frame field(s) (308). In some implementations, the register(s) store bit masks that are compared to frame type number and/or frame version number. If there is a match between the register contents (bit mask) and the field type and/or field version numbers, then the frame is accepted. For example, the incoming frame contains a frame type number and a frame version number (e.g., contained in a frame control field of a header) that are mapped to a corresponding bit in a register(s), respectively. With this approach, several frame type and frame version numbers can be configured by register (s), to pass multi-protocol frame filter 108. If one or more bits in the frame type mask or frame version mask are set (e.g., set to “1”) and the corresponding number of the incoming frame type or frame version matches its corresponding set mask bit, the incoming frame is passed by multi-protocol frame filter 108.

The bit mapping scheme described above allows for design flexibility and extensibility of wireless transceivers by programming “on-the-fly” the multi-protocol frame filter 108 to pass incoming frames of a specific frame type or frame version, multiple frame types or versions, all frame types or versions or no frame types or versions by simply programming the register that corresponds to the protocol specific field with an appropriate bit mask to obtain the desired filter characteristics.

If the frame is accepted (310), a signal is generated indicating acceptance and the frame is stored in a receiver buffer. The signal (e.g., an interrupt signal) can be routed to an external microcontroller unit or other processing unit for further processing or the frame can be passed to one or more other frame filter stages to be compared against one or more frame filter rules (314). If the frame complies with the one or more frame filter rules, the frame stored in the frame buffer is passed and the signal is generated; otherwise the frame is discarded (312).

While this document contains many specific implementation details, these should not be construed as limitations on the scope what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

What is claimed is:

1. A multi-protocol frame filter system, comprising:
one or more programmable registers configured to store frame filter data;
a receiver configured to receive an incoming frame;
a multi-protocol frame filter coupled to the one or more programmable registers and the receiver, the multi-protocol frame filter configured for:
comparing one or more fields of the incoming frame to the frame filter data, where the one or more fields are indicative of a wireless communications protocol; and
determining, based on the comparing, to accept or discard the frame.

2. The system of claim 1, where the frame filter data is a bit mask.

3. The system of claim 2, where the comparing includes comparing bits in the bit mask to one or more numbers in the one or more fields.

4. The system of claim 1, where the frame filter data is compared to a frame type field or frame version field.

5. The system of claim 4, where the multi-protocol frame filter is configured to generate binary signals indicating acceptance or discarding of the frame type or frame version fields.

6. The system of claim 5, further comprising:
if the binary signals indicate that the frame type or frame version are accepted:
comparing one or more other fields of the frame to one or more filter rules; and
if the one or more other fields of the frame comply with the one or more filter rules, passing the frame by the multi-protocol frame filter.

7. The system of claim 6, further comprising:
generating an interrupt signal to further process the frame.

8. The system of claim 1, where the one or more programmable registers, the receiver and the multi-protocol frame filter are included in a wireless transceiver integrated circuit chip.

9. A method of multi-protocol frame filtering, comprising:
programming one or more registers in a wireless transceiver circuit with frame filter data;
receiving, by a receiver of the wireless transceiver circuit, an incoming frame;
comparing, by a multi-protocol frame filter of the wireless transceiver circuit that is coupled to the one or more registers and the receiver, one or more fields of the incoming frame to the frame filter data, where the one or more fields are indicative of a wireless communications protocol; and
determining, based on the comparing, to accept or discard the frame.

10. The method of claim 9, where the frame filter data is a bit mask.

11. The method of claim 10, where the comparing includes comparing bits in the bit mask to one or more numbers in the one or more fields.

12. The method of claim 9, where the frame filter data is compared to frame type or frame version fields.

13. The method of claim 12, where the multi-protocol frame filter is configured to generate binary signals indicating acceptance or discarding of the frame type or frame version fields.

14. The method of claim 13, further comprising:
if the binary signals indicate that the frame type or frame version are accepted:
comparing one or more other fields of the frame to one or more filter rules; and
if the one or more other fields of the frame comply with the one or more filter rules, passing the frame by the multi-protocol frame filter.

15. The method of claim 14, further comprising:
generating an interrupt signal to further process the frame.

16. A multi-protocol frame filter system, comprising:
one or more programmable registers configured to store frame filter data;
a receiver configured to receive an incoming frame having one or more fields, the one or more fields being indicative of a wireless communications protocol and including frame type and frame version fields;
a multi-protocol frame filter configured to:
conduct a first comparison of the one or more fields to the frame filter data;
make a determination, based on the first comparison, to accept the frame type or frame version fields;
conduct a second comparison, based on the determination, of one or more other fields of the frame to one or more filter rules; and
enable a subsequent processing of the frame based on the second comparison indicating that the one or more other fields comply with the one or more filter rules.

17. The system of claim 16, where the frame filter data is a bit mask.

18. The system of claim 17, where the comparing includes comparing bits in the bit mask to one or more numbers in the one or more fields.

19. The system of claim 16, further comprising:
generating an interrupt signal to enable subsequent processing of the frame.

20. The system of claim 16, where the one or more programmable registers, the receiver and the multi-protocol frame filter are included in a wireless transceiver integrated circuit chip.
